(19) United States
(12) Patent Application Publication
(10) Pub. No.: US 2008/0026717 A1
(43) Pub. Date: Jan. 31, 2008

(54) Bandpass-sampling delta-sigma communication receiver

(75) Inventor: Phuong T. Huynh, Annandale, VA (US)

Correspondence Address: POSZ LAW GROUP, PLC, 12040 SOUTH LAKES DRIVE, SUITE 101, RESTON, VA, 20191, US

(73) Assignee: Phuong T. Huynh, Annandale, VA (US)

(21) Appl. No.: 11/495,682

(22) Filed: Jul. 31, 2006

(51) Int. Cl. H04B 1/06; H04B 1/18; H04B 1/16; H04B 7/00

(52) U.S. Cl. 455/266; 455/337; 455/293

(57) ABSTRACT

A bandpass-sampling analog-to-digital demodulator (BS-ADD) is provided. A radio frequency (RF) signal is received by a junction summer, which subtracts a feedback signal from the RF signal to produce an error signal. The error signal is then bandpassed and amplified by the RF bandpass filter/amplifier. The amplified signal is bandpass-sampled by a low-resolution analog-to-digital converter, and is demodulated and converted into a high-resolution digital signal. The down converted signal is multiplied with a clock to be up-converted back to the radio frequency. The resulting multiplied signal is converted to an analog signal and fed back to the junction summer.

### FIELD OF THE INVENTION

The present invention relates in general analog-to-digital conversion in communication systems. More specifically, the invention relates to analog-to-digital demodulation of a signal at radio frequency in a communication system.

### BACKGROUND OF THE INVENTION

Wireless systems are becoming a fundamental mode of telecommunication in modern society. In order for wireless systems to continue to penetrate into the telecommunications market, the cost of providing the service must continue to decrease and the convenience of using the service should continue to increase. In response to increasing market demand, radio standards around the world have been proliferated based upon digital modulation schemes. Consequently, it is often advantageous to have a receiver that is capable of communication using more than one of these standardized techniques. In order to do so, it is necessary to have a receiver that is capable of receiving signals which have been modulated according to several different modulation techniques.

Existing receivers are typically implemented using double conversion (or heterodyne) receiver architectures. A double conversion receiver architecture is characterized in that the received radio-frequency (RF) signal is converted to an intermediate frequency (IF) signal, which is subsequently converted to baseband. In addition, typically gain control is applied to the IF signal. However, double conversion receivers have the disadvantage of using a great number of analog circuit components, thus, increasing the cost, size and power consumption of the receiver.

A direct conversion receiver, also sometimes called a zero-IF receiver, provides an alternative to the traditional double-down conversion architecture. This is particularly attractive for the use in wireless systems, especially in handset devices, since direct conversion receivers lend themselves more easily to monolithic integration than heterodyne architectures. Also, direct conversion exhibits immunity to the problem of image since there is no IF.

However, there exist design issues associated with the direct conversion architecture. The most serious problem is direct current (DC) offset in the baseband, which appears in the middle of the down-converted signal spectrum, and may be larger than the signal itself. This phenomenon is caused by local oscillator leakage and self-mixing. Furthermore, in-phase and quadrature mismatch, occurring in the quadrature down-conversion can lead to corrupted signal constellation, and hence increasing the number of bits in error.

FIG. 1 and FIG. 2 together illustrate the functioning of a conventional analog-to-digital converter (ADC or A/D) using a bandpass sampling technique to demodulate and digitize a RF signal. In particular, FIG. 1 illustrates an exemplary topology and FIG. 2 illustrates the timing of the analog-to-digital demodulation and conversion. FIG. 3 is a block diagram of an exemplary topology, illustrating the functioning of an exemplary conventional bandpass delta-sigma ADC.

Referring now to FIG. 1, a schematic diagram illustrating a conventional circuit for bandpass sampling and down-converting an analog signal to a digital signal will be discussed and described. As shown in FIG. 1, the circuit includes a receive antenna 101, a low-noise amplifier (LNA) 103, a sample-hold circuit 107, and an analog-to-digital converter (A/D) 109.

A received RF signal typically comprises two components: a low-frequency modulating signal that contains the communicating information and a RF carrier. The modulating signal is up-converted to the RF carrier frequency before transmitted through the transmission media. The function of the communication receiver is to down-convert—or commonly said ‘demodulate’—the modulating signal down to baseband so that the communicating information can be decoded.

Reception of a communication signal is done at the antenna 101, wherein the LNA 103 subsequently amplifies the received signal to produce the RF SIGNAL shown in FIG. 1. The RF signal is sampled and held the sample and hold circuit 107. The resulting signal is then provided to the A/D 109, which provides a digital signal output 115 representing the down-converted RF signal (i.e., the demodulated signal). A sampling clock component 113 is provided to the sample and hold circuit 107 and the A/D 109 to control the sample rate.

Referring now to FIG. 2, a timing diagram useful for illustrating an operation of bandpass-sampling and down-conversion in accordance with FIG. 1 will be discussed and described. As shown in FIG. 2, a sinusoidal waveform 201 of the RF carrier is provided, whose frequency is normally in the gigahertz (GHz) range. A plurality of samples 203, 205, . . . , 207 are taken based on the sampling clock. The modulating signal, which carries the communicating information, modulates slowly either the amplitude or the phase of the carrier.

When the sampling clock frequency component 113 of the A/D 109 is much greater than the RF frequency of the carrier, the A/D 109 will capture and digitize the sinusoidal waveform 201 of the carrier as well as the modulating signal. However, when the sampling clock component 113 is equal the RF carrier frequency, the A/D 109 will skip the sinusoidal waveform and capture only one sampled data every period of the RF carrier. In this case, the sampling technique is commonly referred as ‘bandpass-sampling’, and the A/D 109 will output a slowly time-varying digital signal representing the modulating signal that carries the communicating information. When the A/D 109 sampling clock is lower than the RF carrier frequency (e.g., N times lower), the A/D 109 will capture one sampled data portion every N periods of the RF carrier, outputting the same modulating signal as in the bandpass sampling technique. The sampling technique, in this case, is referred to as ‘sub-sampling’ or ‘under-sampling’.

As long as the sub-sampling clock frequency is larger than twice the bandwidth of the modulating signal, no information is lost. In effect, a direct down-conversion process is achieved in a communication receiver using a bandpass-sampling or sub-sampling ADC. Nevertheless, the current advance in technology limits usage of this architecture at RF frequencies. The inherent clock jitter in the sampling clock component 113, due to thermal agitation at the molecule level that generates phase noise in clock oscillators, limits severely the analog-to-digital conversion resolution of the bandpass-sampling A/D 109. Clock phase noise is converted into digital noise at the output of the A/D 109 and reduces considerable the signal-to-noise (SNR) of the receiver system, yielding the system impractical to function. A 12-bit resolution, as required by many communication standards nowadays, is not achievable using the bandpass-sampling topology as illustrated in FIG. 1.

Another prior-art technique has attempted to increase the conversion resolution by adding a feedback and a bandpass filter/amplifier in the loop, as illustrated in FIG. 3. This technique is commonly referred to as bandpass delta-sigma analog-to-digital conversion. As shown in FIG. 3, a bandpass sigma-delta converter includes a receive antenna 301, an LNA 303, a bandpass delta-sigma ADC 305, a multiplier 317, and a decimating filter 321. The bandpass delta-sigma ADC 305 further includes a subtractor 313, an RF bandpass filter/amplifier 307, a low resolution A/D 309, and a D/A 311.

Reception of a communication signal is done at the antenna 301, wherein the LNA 303 subsequently amplifies the received signal and produces the RF SIGNAL shown in FIG. 3, which is provided to the bandpass delta-sigma ADC 305.

The subtractor 313 in the bandpass delta-sigma ADC 305 then subtracts a feedback signal from the RF SIGNAL, and the modified signal is provided to the bandpass filter/amplifier 307 for filtering and amplification. The center frequency of the bandpass filter/amplifier 307 coincides with the RF carrier frequency, and its bandwidth is a fraction of the carrier frequency.

A bandpass delta-sigma ADC 305, as illustrated in FIG. 3, employs a low-resolution A/D 309 and a sampling clock component 315 with frequency of one or two orders of magnitude larger than the RF carrier frequency. The increase in the overall resolution is done by adding a feedback loop with a high-gain bandpass filter 307 to push the quantization noise from the A/D conversion out of the modulating signal band, which is normally a few megahertz (MHz) about the carrier frequency. The SNR in the modulating signal band is therefore increased, thereby increasing the theoretical resolution of the delta-sigma ADC 305 beyond 12 bits.

The down-conversion of the modulating signal can be done in the digital domain by multiplying the A/D 309 output with an RF digital clock 319, as performed by the multiplier 317. The decimating filter component 321 is commonly used to reduce the data rate in the digital domain and filter the out-of-band quantization noise, rendering a high fidelity down-conversion and digitization of the modulating signal component 323.

The delta-sigma technique is sound in theory, but is impractical to realize in reality given the current advance in technology. As stated earlier, the A/D sampling clock 315 has to be one or two orders of magnitude greater than the carrier frequency—thereby often called ‘over-sampling’ clock. For example, given a carrier frequency of 1 GHz, the A/D sampling clock 315 must be around 50 GHz. Excessive clock phase noise from clock 315 will counteract the increase in the bit resolution achieved by the feedback loop containing the D/A 311, and degrade the overall resolution of the delta-sigma converter. Furthermore, digital signal processing (DSP) running at 50 GHz clock rate on the multiplier 317 and the decimating filter 321 is impractical and power consumptive.

Prior-art communication receivers therefore demand heavy analog pre-processing of the received signal before conversion to the digital domain by the analog-to-digital converter (ADC or A/D). Improvements are sought to minimize the analog pre-processing by demodulating and digitizing the received signal directly at radio frequency.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a schematic diagram illustrating a conventional prior art circuit for sampling, demodulating and converting an analog signal to a digital signal;

FIG. 2 is a timing diagram useful for illustrating an operation of the sampling and converting in accordance with FIG. 1;

FIG. 3 is a schematic diagram illustrating another conventional prior art circuit for converting an analog signal to a digital signal;

FIG. 4 is a schematic diagram illustrating an exemplary analog-to-digital demodulator in accordance with various exemplary embodiments;

FIG. 5 is a schematic diagram illustrating an alternative exemplary analog-to-digital demodulator in accordance with one or more embodiments;

FIG. 6 is a schematic diagram illustrating an alternative exemplary analog-to-digital demodulator in accordance with one or more embodiments;

FIG. 7 is a schematic diagram illustrating portions of the alternative exemplary analog-to-digital demodulator of FIG. 5 in more detail;

FIG. 8 is a schematic diagram illustrating portions of the alternative exemplary analog-to-digital demodulator of FIG. 5 in more detail;

FIG. 9 is a schematic diagram illustrating an exemplary direct-conversion communication receiver, in accordance with various exemplary embodiments;

FIG. 10 is a schematic diagram illustrating an exemplary IF-conversion communication receiver, in accordance with various exemplary embodiments;

FIG. 11 is a schematic diagram illustrating an exemplary multi-bands communication receiver, in accordance with various exemplary embodiments.

### DETAILED DESCRIPTION

In overview, the present disclosure concerns electronic devices or units, some of which are referred to as communication units, such as cellular phone or two-way radios and the like, typically having a capability for rapidly handling data, such as can be associated with a communication system such as an Enterprise Network, a cellular Radio Access Network, or the like. More particularly, various inventive concepts and principles are embodied in circuits, and methods therein for receiving signals in connection with a communication unit.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to simplify and minimize the analog components in a communication receiver; and yet provide unprecedented performance by demodulating and digitizing the RF signal at the radio frequency directly to baseband or a low digital IF.

Further in accordance with exemplary embodiments, there is provide an analog-to-digital demodulator employing the bandpass sampling technique with feedback, which will be often referred to as BS-ADD in later embodiments. One or more embodiments provide usage of the bandpass sampling technique to lower the sampling clock frequency of the ADC, which can reduce the power consumption. Furthermore, a novel feedback technique is employed according to various embodiments to increase the conversion resolution of the BS-ADD.

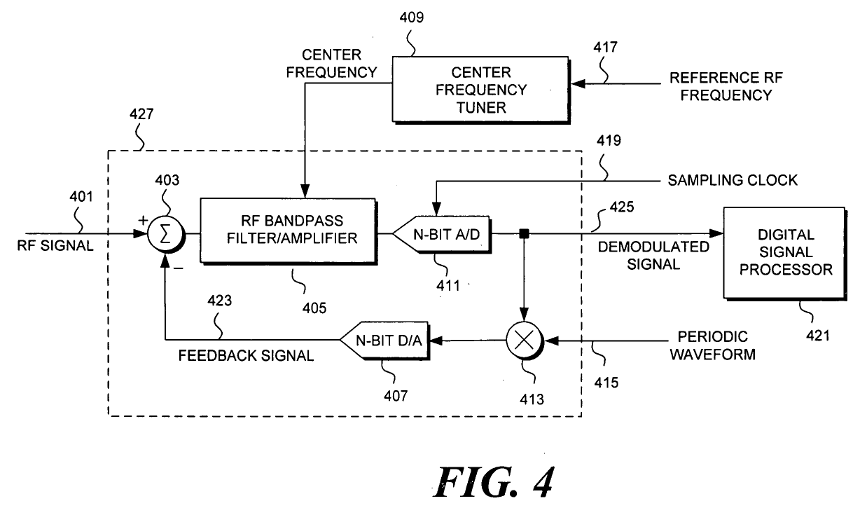

Referring now to FIG. 4, a schematic diagram illustrating an exemplary bandpass-sampling delta-sigma technique in accordance with one or more embodiments will be discussed and described. In overview, the novel feedback technique in conjunction with bandpass-sampling are employed. The illustrated embodiment in FIG. 4 is referred to as ‘bandpass-sampling delta-sigma analog-to-digital demodulator’ or BS-ADD for short. As shown in FIG. 4, the receiver circuit includes a BS-ADD 427, a center frequency tuner 409, and a digital signal processor (DSP) 421. The BS-ADD 427 further includes a feedback summer 403, an RF bandpass filter/amplifier 405, an N-bit D/A 407, a low-resolution N-bit A/D 411, and a feedback multiplier 413.

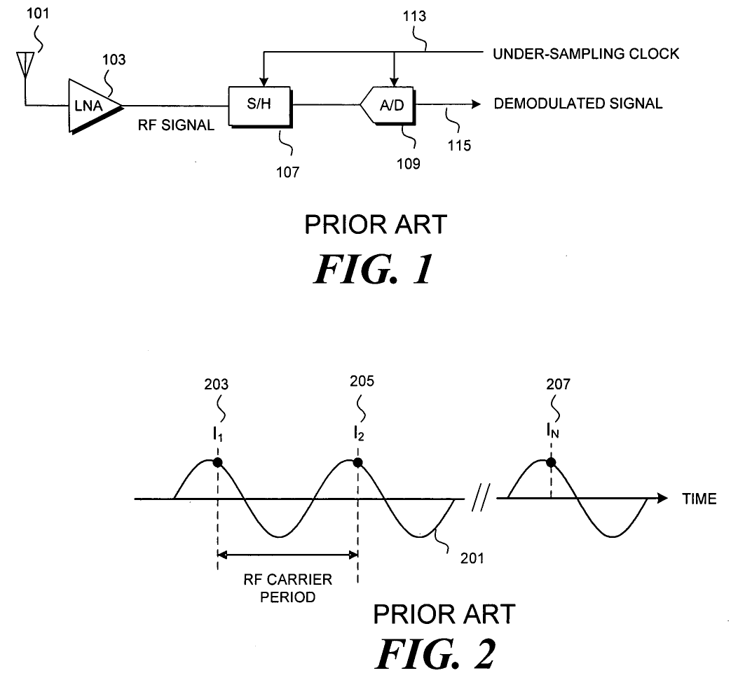

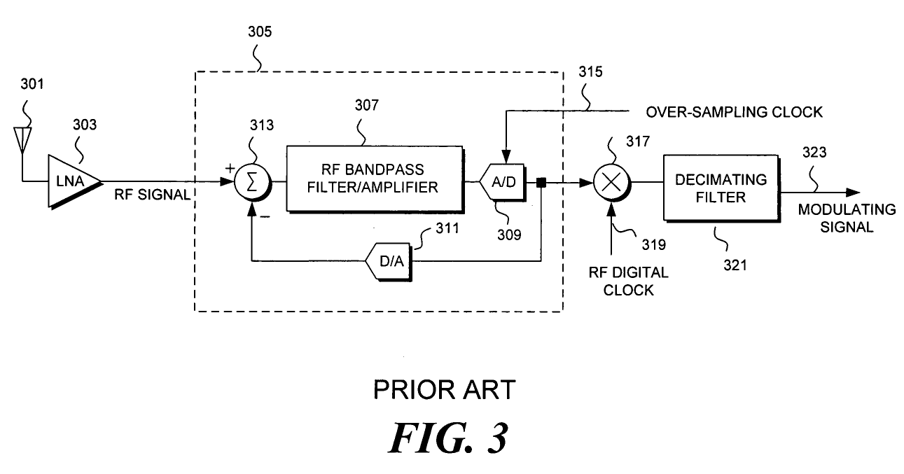

In FIG. 4, an RF signal 401 is understood coming from an LNA as described above with respect to the conventional communication receiver architectures of FIG. 1 and FIG. 3. The feedback summer 403 in the bandpass BS-ADD 427 then subtracts a feedback signal from the RF signal, and the modified signal is provided to the RF bandpass filter/amplifier 405 for filtering and amplification. The center frequency of the RF bandpass filter/amplifier 405 preferably coincides with the RF carrier frequency, and its bandwidth is preferably a fraction of the carrier frequency.

The output of the RF bandpass filter/amplifier 405 is provided to the N-bit A/D 411, which is bandpass sampled or sub-sampled by the sampling clock 419. By using the bandpass-sampling technique as discussed earlier in conjunction with FIG. 1 and FIG. 2, the N-bit A/D 411 demodulates the modulating signal that carries the communicating information from the input RF signal 401 to generate a demodulated signal 425, which is provided to the digital signal processor 421.

The demodulated signal 425 is also fed back to the feedback summer 403 through the feedback multiplier 413 and the N-bit D/A 407. The multiplier 413 is employed to make the feedback loop function properly, and push the quantization noise generated from the N-bit A/D 411 out of the modulating signal band. Since the bandpass-sampling N-bit A/D 411 produces the demodulated signal 425, the latter must be up-converted to the RF carrier frequency, so that a proper comparison can be made between the input RF signal 401 and the feedback signal 423 at the feedback summer 403 to generate a correct error signal at the bandpass filter/amplifier 405 input. The up-conversion of the demodulated signal 425 back to the RF carrier frequency is done by multiplying signal 425 with a periodic waveform 415 in the multiplier 413.

The frequency of the periodic waveform 415 can be lower, equal, or higher than the RF carrier frequency. When the frequency of the periodic waveform is equal to the RF carrier frequency, the demodulation process is called ‘direct conversion’. However, when the frequency of the periodic waveform is lower or higher than the RF carrier frequency, the demodulation process is called ‘IF conversion’. The modulating signal is digitized and down-converted to an intermediate frequency, and the second down-conversion to baseband can be done in the digital domain. Subsequent digital signal processing of the modulating signal is done at the DSP 421. In comparison with the conventional prior art delta-sigma analog-to-digital conversion as illustrated in FIG. 3, the embodiment in FIG. 4 does not require a very high ADC sampling clock, nor intensive post demodulation in the digital domain using a high clock rate.

In the exemplary embodiment illustrated in FIG. 4, demodulating of RF signals at various carrier frequencies can also be done by the center frequency tuner 409. Programmable software can be used by inputting a reference RF frequency 417 to the tuner 409 to center the bandpass filter 405 at a specific RF carrier frequency. The sampling clock 419 frequency and the periodic waveform 415 frequency can also be derived from the reference RF frequency 417 by software, making the BS-ADD topology truly software programmable to demodulate signals at any RF frequency.

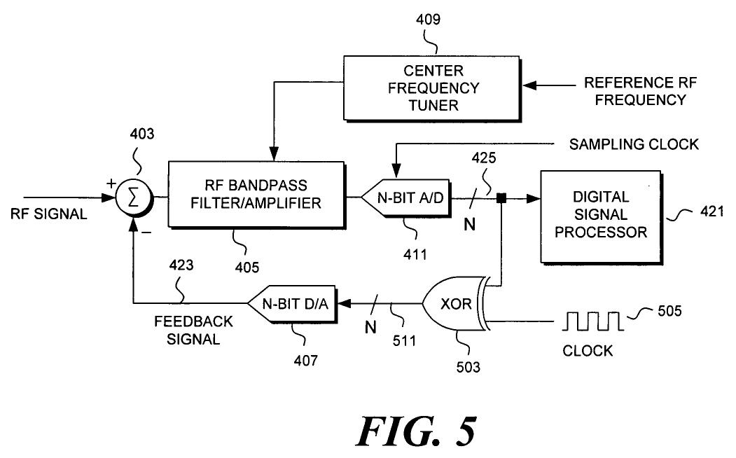

Referring now to FIG. 5, a schematic diagram illustrating an alternative exemplary bandpass-sampling delta-sigma analog-to-digital demodulation in accordance with one or more embodiments will be discussed and described. The illustrated embodiment provides an alternative where the feedback multiplier 413 in the feedback loop can be replaced by a set of exclusive-OR (XOR)circuits 503.

The feedback multiplier 413 in FIG. 4 can be modified by simplifying the periodic waveform 415 to a bi-level digital clock 505 illustrated in FIG. 5. The XOR operation is equivalent to a multiplication when its inputs are binary. The multiplier 413 can be replaced by a plurality of XOR circuits 503 that receive the N output bits of the demodulated signal 425 of the N-bit A/D 411. Each output bit of the N-bit A/D 411 is XORed with the clock 505. The resulting N XOR outputs 511 enter the N-bit D/A 407 in the same order as the N-bit A/D outputs 425; namely the most significant bit of the N-bit A/D 411, after the XOR operation, will become the most significant input bit of the N-bit D/A 407.

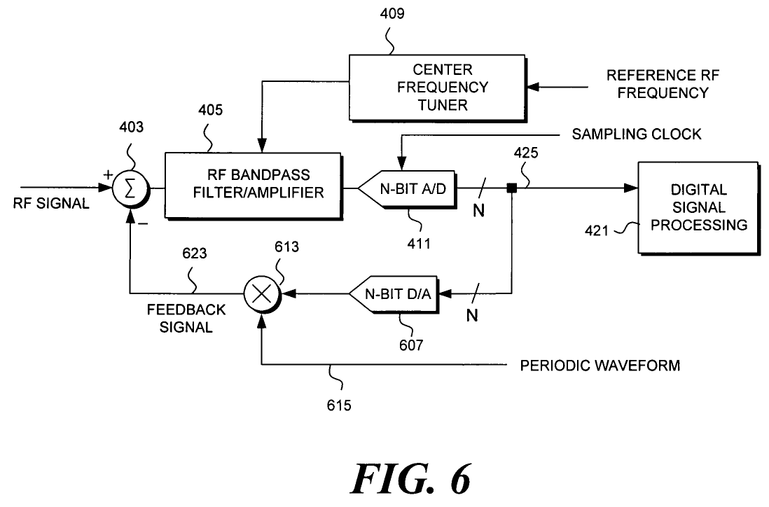

FIG. 6 provides another alternative exemplary illustration of the embodiment. As shown in FIG. 6, a multiplier 613 in the feedback path can be placed after the N-bit D/A 407, rather than before, without changing the functionality of the preferred embodiment in FIG. 4. In this case, the multiplication is done in the analog domain. The N-bit A/D 411 outputs are fed directly to the N-bit D/A 607, which converts the demodulated signal 425 into an analog signal. The latter is then multiplied with an analog periodic waveform 615, such as a sinusoidal waveform. The net effect of the multiplication performed in the feedback multiplier 613 is to up-convert the demodulated signal 425 back to the radio frequency, and the resulting feedback signal 623 is fed to the feedback summer 403.

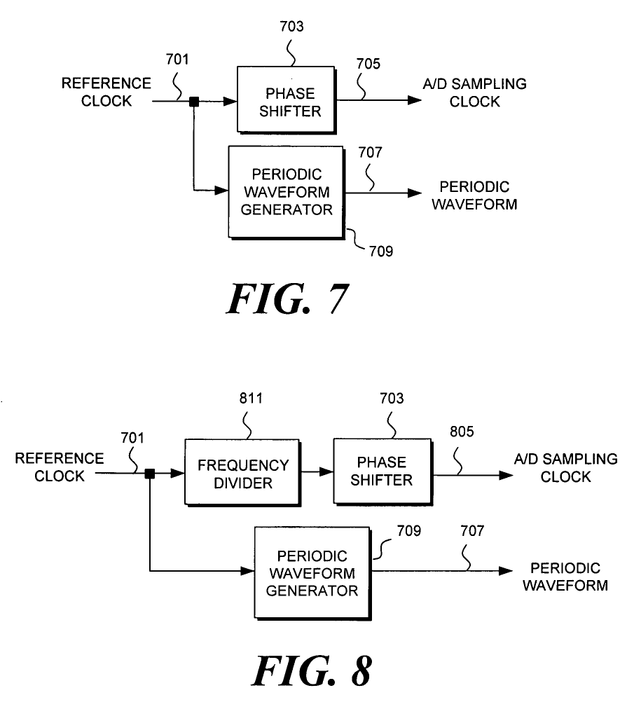

FIG. 7 and FIG. 8 provide exemplary illustrations of one or more embodiments. They provide generation of the ADC sampling clock and the periodic waveform and their specific phase relationship based on a reference master clock.

Referring now to FIG. 7, a schematic diagram illustrating portions of the exemplary BS-ADD circuit for various embodiments is provided. In this embodiment, the A/D sampling clock 705 has the same frequency as the periodic waveform 707, both of which can be derived from a single reference clock 701. As shown in FIG. 7, the disclosed signal generation circuit includes a phase shifter 703 and a periodic waveform generator 709.

The periodic waveform generator 709 uses the reference clock 701 to generate the periodic waveform, which can be either digital or analog as required by the current embodiment. The phase shifter 703 sets the timing (or phase) of the A/D sampling clock 705 in relation to the timing (or phase) of the periodic waveform 707.

Referring now to FIG. 8, a schematic diagram illustrating alternative portions of the BS-ADD for exemplary embodiments is provided wherein sub-sampling is used instead of bandpass sampling. As shown in FIG. 8, the disclosed signal generation circuit includes a phase shifter 703, a periodic waveform generator 709, and a frequency divider 811.

The frequency divider 811 divides the reference clock 701 by N (where N is a positive integer greater than zero) before it is provided to the phase shifter 703. However, the periodic waveform generator 709 uses the reference clock 701 directly to generate the periodic waveform, which again can be either digital or analog as required by the current embodiment.

The frequency of a resulting A/D sampling clock 805 is thus N times smaller than the frequency of the periodic waveform 707. As noted above with respect to FIG. 2, sub-sampling digitizes one sample point 203, 205, . . . , 207 every N periods of the RF carrier waveform 201. As long as the sub-sampling A/D clock rate 805 is larger than twice the Nyquist bandwidth of the modulating signal, no information is lost in the receiving. Also, it is understood that placement of the frequency divider 811 in FIG. 8 is arbitrary. The frequency divider 811 can be positioned before or after the phase shifter 703 without losing functionality.

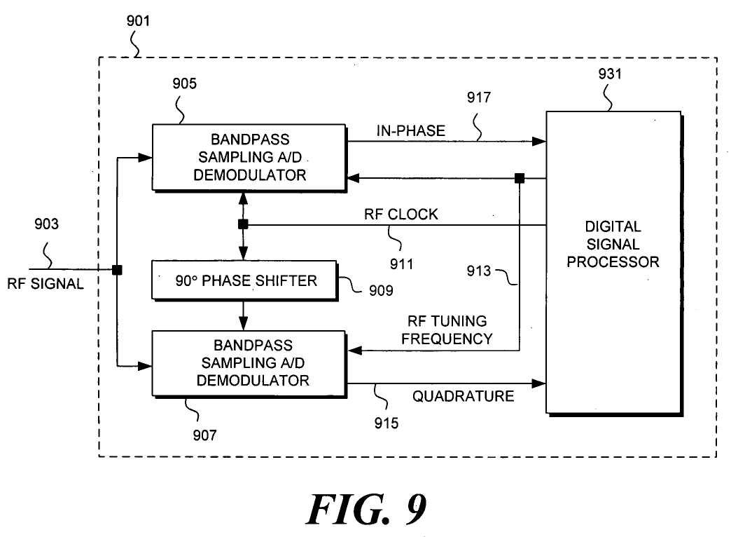

Referring now to FIG. 9, a functional block diagram illustrating an exemplary communication receiver 901 arranged for receiving data utilizing two BS-ADDs, in accordance with various exemplary embodiments will be discussed and described. As shown in FIG. 9, the communication receiver 901 includes a BS-ADD 905, a BS-ADD 907, a 90° phase shifter 909, and a digital signal processor (DSP) 931.

The communication unit 901 in FIG. 9 is referred to as a direct-conversion quadrature receiver, in which the configuration of two BS-ADDs 905 and 907 allows for the demodulation of both an in-phase signal 917 and a quadrature signal 915 in a quadrature-transmission communication system.

In a direct-conversion quadrature receiver unit 901, an RF clock 911 is used to generate both the sampling clock for the N-bit A/D 411, and the periodic waveform for the BS-ADD. Direct conversion means demodulation of the RF signal at the carrier frequency directly down to baseband, which dictates that the RF clock 911 must have the same frequency as the frequency of the RF carrier 903. To extract the in-phase and quadrature components 917 and 915, the 90° phase shifter 909 is needed to separate the phases of the RF clocks provided to the BS-ADD 905 and the BS-ADD 907 by ninety degrees. Once generated, the in-phase 917 and quadrature 915 components are input to the DSP 931 for further signal processing.

The DSP 931 can also control the tuning of the RF carrier frequency 903 by outputting a RF tuning frequency 913 to both BS-ADDs 905 and 907. This feature allows programmability to the communication receiver 901 to have the ability to receive RF signals in a wide range of frequencies of interest.

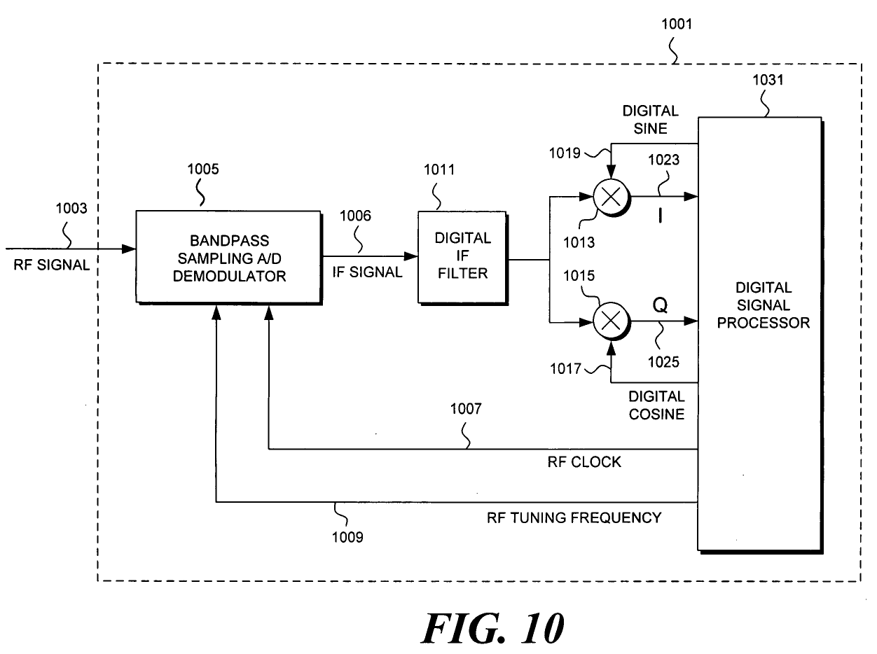

Referring now to FIG. 10, a functional block diagram illustrating an alternative exemplary communication receiver 1001 arranged for receiving data using one BS-ADD, in accordance with various exemplary embodiments will be discussed and described. The communication unit 1001 is referred to as a digital intermediate frequency (DIF) quadrature receiver, wherein the RF signal 1003 is down-converted to a low IF and digitized by the BS-ADD. Second down-conversion to baseband is done in the digital domain. As shown in FIG. 10, the communication unit 1001 includes a BP-ADD 1005, a digital IF filter 1011, a digital multiplier 1013, a digital multiplier 1015, and a digital signal processor (DSP) 1031.

To down-convert to a low IF, an RF clock 1007 is set by the DSP 1031 to a frequency close to the carrier frequency of the input RF signal 1003. The RF clock 1007 can have frequency higher or lower than the carrier frequency. The low IF is equal to the absolute of the difference between the carrier frequency and the RF clock 1007. A digitized IF signal 1006 is generated by the BS-ADD 1005 and is input to a digital IF filter 1011. More specifically, the digital IF filter 1011 is preferably a decimation filter used to remove the quantization noise outside the band of the IF signal 1006, increase the conversion bit resolution, and decimate the data rate from the RF clock rate to a lower data rate comparable to the IF.

Down-conversion to baseband and extraction of in-phase 1023 and quadrature 1025 components are done using the digital multipliers 1013 and 1015. Two sinusoids 1017 and 1019 are generated by the DSP 1031. The two sinusoids are ninety degree out of phase (e.g., they are a sinusoid and a cosinusoid, such as sine and cosine) and their frequencies are equal to the low IF. The IF signal coming out of the digital IF filter 1011 is multiplied with the digital sinusoid 1019 to generate the in-phase component 1023 at baseband. Likewise, the IF signal is multiplied with the digital cosinusoid 1017 to generate the quadrature component 1025 at baseband.

The DSP 1031 can also control tuning of the carrier frequency of the RF signal 1003 by controlling the RF tuning frequency 1009 provided to the BS-ADD 1005. This feature allows programmability to the communication receiver 1001 to have the ability to receive RF signals in a wide range of frequencies of interest.

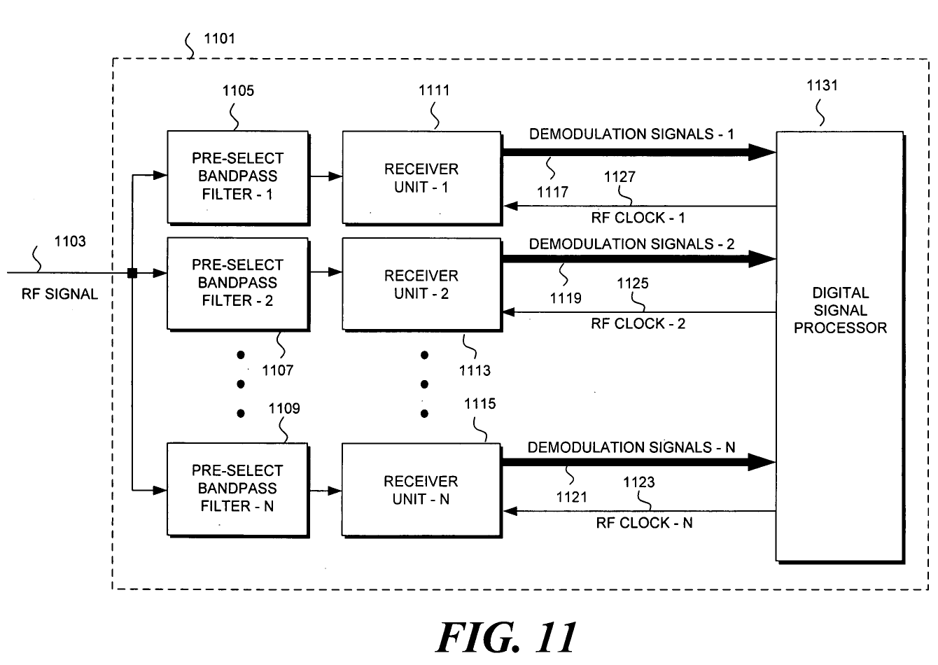

Referring now to FIG. 11, a functional block diagram illustrating an alternative exemplary communication receiver 1101 arranged for receiving data simultaneously at multiple RF bands, in accordance with various exemplary embodiments will be discussed and described. As shown in FIG. 11, the communication unit 1101 includes N pre-select bandpass filters 1105, 1107, . . . , 1109, N receiver units 1111, 1113, . . . , 1115, and a digital signal processor (DSP) 1131.

The communication unit 1101 may be referred to as a multi-band digital receiver, wherein the plurality of receiver units 1111, 1113, and 1115, are used in parallel. Each of the receiver units 1111, 1113, and 1115 can be a communication unit 901 in FIG. 9 or the communication unit 1001 in FIG. 10. The pre-select bandpass filters 1105, 1107, and 1109 are used to separate the RF input signals 1103. The digital processor 1131 generates different RF clocks 1123, 1125, 1127, each of which correspond to a pre-determined receiving RF band. The demodulated signals 1117, 1119, and 1121 out of the communication units 1111, 1113, and 1115, respectively, are input to the digital processor 1131 for further signal processing.

The DSPs 931, 1031, and 1131 in FIG. 9, FIG. 10, and FIG. 11, respectively, may comprise on or more microprocessors and/or one or more digital signal processors. The DSPs 931, 1031, and 1131 may also represent a large-scale computer or the like comprising a read-only memory (ROM), a random-access memory (RAM), a programmable ROM (PROM), and/or an electrically erasable read-only memory (EEPROM). The processors may include multiple memory locations for storing, among other things, an operating system, data and variables for programs executed by the processors; computer programs for causing the processors to operate in connection with other various functions such as receiving data, digital filtering, digital signal processing and/or other processing.

It should be noted that the term communication unit may be used herein to denote a wired device, for example a high speed modem, an xDSL type modem, a fiber optic transmission device, and the like, and a wireless device, and typically a wireless device that may be used with a public network, for example in accordance with a service agreement, or within a private network such as an enterprise network or an ad hoc network. Examples of such communication devices include a cellular handset or device, television apparatus, personal digital assistants, personal assignment pads, and personal computers equipped for wireless operation, and the like, or equivalents thereof, provided such devices are arranged and constructed for operation in connection with wired or wireless communication.

The communication units of particular interest are those providing or facilitating voice communications services or data or messaging services normally referred to as ultra wideband networks, cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5 G and 3 G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore, the wireless communication devices of interest may have short range wireless communications capability normally referred to as WLAN (wireless local area network) capabilities, such as IEEE 802.11, Bluetooth, WPAN (wireless personal area network) or Hiper-Lan and the like using, for example, CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication devices of interest may be connected to a LAN using protocols such as TCP/IP, UDP/UP, IPX/SPX, or Net BIOS via a hardwired interface such as a cable and/or a connector.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A circuit for receiving a radio frequency signal and providing a demodulated digital signal, comprising:
a summer configured to receive the radio frequency signal and a feedback signal, and to produce an analog error signal responsive to a difference between the radio frequency signal and the feedback signal;
a bandpass filter and amplifier configured to perform a bandpass and amplification operation on the analog error signal to produce an amplified error signal;
an analog-to-digital converter configured to produce a digital signal responsive to the amplified error signal and a sampling clock;
a conversion circuit configured produce the feedback signal based on the digital signal and a periodic signal; and
a center frequency tuner, receiving a reference input frequency and producing a respective control signal to tune the center frequency of the bandpass filter to said radio frequency signal.

2. The circuit of claim 1, wherein the analog-to-digital converter has an N-bit resolution, where N is a positive number.

3. The circuit of claim 1, wherein the digital-to-analog converter has an N-bit resolution, where N is a positive number.

4. The circuit of claim 1, wherein the multiplier comprises a plurality of exclusive-OR circuits, each of the plurality of exclusive-OR circuits being configured to receive the periodic signal and a corresponding bit from the analog-to-digital converter, and to produce a respective digital output signal.

5. The circuit of claim 1, wherein the conversion circuit comprises:
a multiplier configured to multiply the digital signal with a periodic signal to produce a multiplied signal; and
a digital-to-analog converter configured to convert the multiplied signal from an analog format to a digital format to produce the feedback signal.

6. The circuit of claim 1, wherein the conversion circuit comprises:
a digital-to-analog converter configured to convert the digital signal from an analog format to a digital format to produce a converted signal; and
a multiplier configured to multiply the converted signal with a periodic signal to produce the feedback signal.

7. The circuit of claim 1, wherein a center frequency of the bandpass filter and amplifier is equal to a signal frequency of the radio frequency signal.

8. The circuit of claim 1, further comprising a periodic waveform generator configured to generate the periodic signal having a periodic signal frequency substantially equal to a reference frequency of a reference clock.

9. The circuit of claim 1, further comprising a phase shifter configured to receive a reference clock and to produce the sampling clock having a sampling clock phase that is phase shifted with respect to a periodic signal phase of the periodic signal.

10. The circuit of claim 9, further comprising a clock divider configured to divide one of the reference clock and the sampling clock such that a sampling frequency of the sampling clock is divided by a positive integer factor with respect to the reference clock.

11. The circuit of claim 9, wherein a frequency of the reference clock is greater than or equal to a radio frequency of the radio frequency signal.

12. The circuit of claim 9, wherein a frequency of the reference clock is less than or equal to a radio frequency of the radio frequency signal.

13. A method for demodulating and digitizing said radio frequency signal to a digital signal in a circuit, comprising:
subtracting a feedback signal from the radio frequency signal to generate an analog error signal;
bandpass filtering and amplifying the analog error signal to generate an amplified error signal;
bandpass-sampling the amplified error signal in response to a sampling clock to generate a sampled error signal;
digitizing the sampled error signal to produce a digital demodulated signal;
converting the digital demodulated signal to the feedback signal in response to a periodic signal, the feedback signal having an up-converted frequency substantially equal to a radio frequency of the radio frequency signal.

14. The method of claim 13, further comprising tuning a center frequency used for the bandpass sampling to be substantially equal to the radio frequency.

15. The method of claim 13, wherein the bandpass sampling is sub-sampling.

16. The method of claim 13, wherein the process of converting the digital demodulated signal to the feedback signal comprises
multiplying the digital demodulated signal with a periodic signal to generate an up-converted signal; and
converting the up-converted signal from a digital format to an analog format to generate the feedback signal.

17. The method of claim 13, wherein the process of converting the digital demodulated signal to the feedback signal comprises
converting the digital demodulated signal from a digital format to an analog format to generate an intermediate signal; and
multiplying the intermediate signal with a periodic signal to generate the feedback signal.

18. The method of claim 13, wherein the process of converting the digital demodulated signal to the feedback signal comprises
performing an exclusive-OR operation on each respective bit of the digital demodulated signal with respect to a periodic signal to generate an up-converted signal; and
converting the up-converted signal from a digital format to an analog format to generate the feedback signal.

19. The method of claim 13, further comprising generating the periodic signal from a reference clock.

20. The method of claim 13, wherein the sampling clock has a sampling phase that is phase shifted with respect to a periodic signal phase of the periodic signal.

21. The method of claim 13, wherein the sampling clock has a sampling frequency that is substantially equal to a periodic frequency of the periodic signal divided down by a positive integer.

22. A demodulating and digitizing radio-frequency communication receiving system, comprising:
a primary bandpass-sampling analog-to-digital demodulator configured to receive a primary incoming signal and to generate a primary demodulated intermediate frequency signal; and
a digital signal processor configured to receive the primary demodulated intermediate frequency signal.

23. The system of claim 22, further comprising:
a first multiplier configured to multiply the primary demodulated intermediate frequency signal with a sinusoidal signal to generate an in-phase signal; and
a second multiplier configured to multiply the primary demodulated intermediate frequency signal with a co-sinusoidal signal to generate a quadrature signal;
wherein a reference sampling clock provided to the primary bandpass-sampling analog-to-digital demodulator is not equal to the carrier radio frequency, and
wherein the first and second primary multipliers operate to down-convert the primary demodulated intermediate frequency signal to baseband.

24. The system of claim 22, further comprising one or more additional bandpass-sampling analog-to-digital demodulators formed in parallel with the primary bandpass-sampling analog-to-digital demodulators, the one or more additional bandpass-sampling analog-to-digital demodulators being configured to receive one or more additional incoming signals and to generate one or more additional demodulated intermediate frequency signals, respectively.

25. The system of claim 23, further comprising a plurality of pre-select bandpass filters, each of the plurality of pre-select bandpass filters being configured to receive a radio frequency signal, to perform a bandpass filtering operation on the radio frequency signal to generate a filtered signal, and to provide the filtered signal to either the primary bandpass-sampling analog-to-digital demodulator or to one of the one or more additional bandpass-sampling analog-to-digital demodulators,
wherein each of the primary bandpass-sampling analog-to-digital demodulator and the one or more additional bandpass-sampling analog-to-digital demodulators receive a different reference clocks.

26. The system of claim 23, and further comprising
a reference clock generator configured to generate a first reference clock for the primary bandpass-sampling analog-to-digital demodulator; and
a ninety-degree phase shifter configured to phase shift the first reference clock by ninety degrees to generate a second reference clock for one of the one or more additional bandpass-sampling analog-to-digital demodulators.
